(19) United States
(12) Patent Application Publication
(10) Pub. No.: US 2015/0013987 A1
(43) Pub. Date: Jan. 15, 2015

(54) METHOD FOR REDUCING SULFIDE IN OILFIELD WASTE WATER AND MAKING TREATED WATER

(71) Applicants: Timothy Underwood, Houston, TX (US); Armando Gomez, Houston, TX (US); Larry Gene Hines, Odessa, TX (US); Jenifer Lascano, Odessa, TX (US)

(72) Inventors: Timothy Underwood, Houston, TX (US); Armando Gomez, Houston, TX (US); Larry Gene Hines, Odessa, TX (US); Jenifer Lascano, Odessa, TX (US)

(73) Assignee: BAKER HUGHES INCORPORATED, Houston, TX (US)

(21) Appl. No.: 13/939,511

(22) Filed: Jul. 11, 2013

(51) Int. Cl. C02F 1/72; E21B 43/40

(52) U.S. Cl. CPC C02F 1/722; E21B 43/40
USPC 166/305.1; 210/721

(57) ABSTRACT

A process for treating oilfield waste water includes contacting the oilfield waste water with hydrogen peroxide, the oilfield waste water comprising sulfide; oxidizing the sulfide to sulfur; and precipitating the sulfur to form treated water from the oilfield waste water. A process for recycling oilfield waste water includes combining the oilfield waste water and hydrogen peroxide, the oilfield waste water comprising sulfide; oxidizing the sulfide to sulfur; forming a precipitate comprising a colloidal sulfur precipitate, a bulk sulfur precipitate, or a combination comprising at least one of the foregoing; removing the precipitate from the oilfield waste water to form treated water; introducing an additive to the treated water; and disposing the treated water in a subterranean environment.

### BACKGROUND

Industrial, commercial, and residential use of water typically adulterates the water by addition of contaminating substances. In residential systems, a common adulterant is spent laundry detergent, which contains large amounts of sulfates. In commercial and industrial settings, water is used as a coolant, drainage agent, dilution compound, solvent, and the like. A particular use of water in some commercial environments involves power washing of objects such as sidewalks and buildings. Additionally, even if not involved directly in operations, water can become part of industrial settings as in mining where pools of water collect in shafts, abandoned mine tunnels, open mine strips, and similar features. These pools of water collect vast amounts of minerals and acids. A common issue with each area of use is the accumulation of hard water ions, e.g., divalent alkali metals. Water treatment can be costly and time consuming and does not always reduce contaminants in the water below a level such that the water is suitable for reuse.

Water also is used for stimulation of hydrocarbon and natural gas wells as well as in hydraulic fracturing. Recently, hydraulic fracturing has dramatically increased the amount of hydrocarbon production. Large volumes of fresh water injection coupled with water conservation efforts have increased an emphasis on oilfield water management such as water reuse. However, reuse of oilfield waste water poses a challenge. Moreover, the chemical composition of municipal and industrial waste water differs from oilfield water. As a result, these types of water have different physical and chemical properties, and their treatment for reclamation also diverges.

A particular aspect of used oilfield water is that it typically contains hydrogen sulfide. Removal of the hydrogen sulfide is warranted if the waste water is to be reused because hydrogen sulfide is corrosive, toxic, and flammable. Attempts to remove hydrogen sulfide from water include sulfide ion complexation, aeration, and stripping. These methods have various degrees of efficiency and removal efficacy.

The development of processes and systems to treat water and decrease hydrogen sulfide in the water is very desirable.

### BRIEF DESCRIPTION

The above and other deficiencies are overcome by, in an embodiment, a process for treating oilfield waste water, the process comprising: contacting the oilfield waste water with hydrogen peroxide, the oilfield waste water comprising sulfide; oxidizing the sulfide to sulfur; and precipitating the sulfur to form treated water from the oilfield waste water.

In an additional embodiment, a process for treating oilfield waste water comprises: contacting oilfield waste water with hydrogen peroxide in the absence of a sulfide oxidizing catalyst, the oilfield waste water comprising sulfide; oxidizing sulfide to sulfur; and forming a colloidal sulfur precipitate, a bulk sulfur precipitate, or a combination comprising at least one of the foregoing.

In a further embodiment, a process for recycling oilfield waste water comprises: combining oilfield waste water and hydrogen peroxide, the oilfield waste water comprising sulfide; oxidizing the sulfide to sulfur; forming a precipitate comprising a colloidal sulfur precipitate, a bulk sulfur precipitate, or a combination comprising at least one of the foregoing; removing the precipitate from the oilfield waste water to form treated water; introducing an additive to the treated water; and disposing the treated water in a subterranean environment.

### BRIEF DESCRIPTION OF THE DRAWINGS

The following descriptions should not be considered limiting in any way. With reference to the accompanying drawings, like elements are numbered alike:

FIG. 1 shows a system for sulfide reduction and formation of treated water from oilfield waste water;

FIG. 2 shows photographs of a sample of oilfield waste water that includes hydrogen sulfide during sulfide reduction treatment in which a precipitate forms after addition of hydrogen peroxide; and

FIG. 3 shows a graph of friction reduction versus time for oilfield waste water subjected to hydrogen peroxide oxidation.

### DETAILED DESCRIPTION

A detailed description of one or more embodiments is presented herein by way of exemplification and not limitation.

It has been found that hydrogen peroxide efficiently treats oilfield waste water that contains sulfide with formation of a colloidal or bulk sulfur precipitate. The hydrogen peroxide converts sulfide to sulfur in the aqueous solution for high and low amounts of sulfide in the water. Produced water and flowback water having high H₂S content and treated with the hydrogen peroxide form colloidal precipitates without the addition of a transition metal catalyst even at an elevated pH. Thus, the produced water and flowback water is reused as a hydraulic fracturing fluid or in enhanced oil recovery applications. Moreover, the methodology is simple and low cost for the removal of the hydrogen sulfide from natural gas or liquid streams with concomitant formation of colloidal or bulk sulfur precipitates. The oxidation and precipitation is environmentally friendly and facile.

Furthermore, the hydrogen peroxide oxidation chemistry presented herein involves a green chemical oxidizer for hydrogen sulfide mitigation. Ordinarily, an oxidizer fully oxidizes sulfide to sulfate without formation of a precipitate, e.g., the colloidal or bulk sulfur precipitate reported herein.

Many oxidants have a complex chemistry with H₂S. Changes in the concentration of the oxidizer or hydrogen sulfide or changes in pH alter the reaction end products. Moreover, the oxidation products depend on the oxidation state of the constituent atoms in the oxidizer and sulfur in the reactants. Hydrogen peroxide added to oilfield waste water provides a straight forward means to oxidize sulfide in the oilfield waste water without any catalyst added to the oilfield waste water. An exemplary oxidation-reduction reaction includes H₂S+H₂O₂→S⁰+H₂O, with a noticeable absence of sulfate production. Here, an absence of a catalyst, e.g., a sulfide oxidation catalyst such as a transition metal catalyst (nickel, vanadium, iron, and the like), prevents formation of sulfate. In the context of reuse of water (e.g., hydraulic fracturing), a sulfur precipitate is removed before further usage so that potential formation damage is avoided.

In an embodiment, a method for treating oilfield waste water includes contacting the oilfield waste water with hydrogen peroxide. The oilfield waste water contains sulfide, which is oxidized to sulfur. The sulfur is precipitated to form treated water from the oilfield waste water. The sulfur precipitate is a colloidal sulfur precipitate, a bulk sulfur precipitate, or a combination comprising at least one of the foregoing. Such precipitate formation occurs from oxidizing the sulfide or an oxidation product of the sulfide. According to an embodiment, the sulfide present in the oilfield waste water is eliminated or quantitatively oxidized into the sulfur precipitate. Furthermore, it is contemplated that other sulfur containing constituents of the oilfield waste water also are precipitated. According to an embodiment, sulfate present in the oilfield waste water or any sulfate that is formed in the oxidation of sulfide are precipitated as well. In some embodiments, certain cations present in the oilfield water or added to the oilfield waste water cause sulfate precipitation in an amount that depends, e.g., on pH. In an embodiment, a polyvalent ion (e.g., a divalent alkaline earth metal such as Ca²⁺, Sr²⁺, Ba²⁺, and the like) is present such that the sulfate solubility depends on the pH or the solubility product constant of the particular sulfate compound (e.g., CaSO₄). Therefore, the pH is controlled in some embodiments to ensure that the sulfate remains soluble or is precipitated. In one embodiment, the amount of such polyvalent ions is controlled generally or selectively (such as by ionic species) to cause sulfate precipitation in addition to sulfur precipitation. The polyvalent ion is, e.g., sequestered, complexed, or reacted by a reagent.

It is contemplated that the colloidal or bulk precipitate includes elemental sulfur, which, in some instances is covalently bonded to other atomic species. The colloidal precipitate is removed from oilfield waste water to form treated water. The method herein advantageously forms the sulfur precipitate without the hydrogen peroxide being in the presence of a catalyst added to the oilfield waste water.

In an embodiment, the oilfield waste water is a product of injecting water downhole or is formation water that flows from the formation to the surface. Exemplary oilfield waste water includes produced water, flowback water, settling pond water, water-flooding fluid, reserve pit water, or various recovered fluids such as drilling fluid, drilling mud, completion fluid, work over fluid, packer fluid, stimulation fluid, conformance control fluid, permeability control fluid, consolidation fluid, or a combination comprising at least one of the foregoing. Recovered fluids such as drilling fluid refer to any type of fluid pumped into a subterranean environment (e.g., a downhole, a borehole, a formation, and the like) during drilling, production, maintenance, or a restoration process. In some embodiments, the drilling fluid is treated water made by combining the hydrogen peroxide and the oilfield waste water and contains or does not contain additives. Produced water typically is water that flows to the surface during production of oil and gas from a subterranean hydrocarbon source. Flowback water, on the other hand, generally is water that flows to the surface after performing a hydraulic fracturing job. The oilfield waste water (e.g., produced water or flowback water) contains a plurality of neutral and ionic species that include the elements aluminum, antimony, arsenic, barium, boron, cadmium, calcium, carbon, chlorine, chromium, cobalt, copper, gallium, germanium, hafnium, indium, iron, lanthanum, lead, magnesium, manganese, mercury, molybdenum, nickel, niobium, potassium, phosphorus, radium, selenium, silicon, silver, sodium, strontium, sulfur, tantalum, tellurium, thallium, tin, titanium, tungsten, vanadium, zinc, zirconium, or a combination thereof. In an embodiment, these elements are present as an ionic species that are hydrated, complexed, combined with another species, or a combination thereof. The oilfield waste water also includes polyatomic species such as SO₄²⁻, HCO₃⁻, CO₃²⁻, H₂S, and the like as well as other components, including oil, grease, and dissolved solids. The concentration of these species changes from source to source and also varies in time, even from the same source (e.g., the same well). It should be noted that due to the composition of oilfield waste water, remediation of the oilfield waste water by oxidative removal of sulfide differs from treatment of other water such as municipal water, drinking water, cooling water, mine shaft water, and the like.

In addition to hydrogen peroxide, a secondary oxidizer is added to the oilfield waste water in certain embodiments. The secondary oxidizer oxidizes material in the oilfield waste water such as organic compounds, inorganic species, and the like. In an embodiment, the secondary oxidizer includes, for example, an inorganic compound or organic compound such as halogen oxidizers (e.g., chlorine dioxide, chlorine gas, sodium hypochlorite, hypobromous acids, chlorates such as KClO₃, and the like), oxygen oxidizers (e.g., peroxy acids, ozone, oxygen, permanganate, and the like), peroxides (e.g., calcium peroxide, magnesium peroxide, ketone peroxides, diacyl peroxides, diakyl peroxides, peroxyesters, peroxyketals, hydroperoxides, peroxydicarbonates, peroxymonocarbonates, and the like), nitrates (e.g., R(NO₃)ₓ), nitrites (e.g., RNO₂), dichromates (e.g., potassium dichromate), and combinations thereof. Exemplary oxidizers also include peroxydisulfate salts, persulfate salts, acetylacetone peroxide, methylethylketone peroxide, cyclohexanone peroxide, methylisobutylketone peroxide; benzoyl peroxide, lauroyl peroxide, isobutyryl peroxide, acetyl peroxide, 2,4-dichlorobenzoyl peroxide, succinic acid peroxide, decanoyl peroxide, diisononanoyl peroxide; tert-butyl peroxide-2-ethyl hexanoate; 1,1-ditert-butylperoxy-3,3,5-trimethyl cyclohexane, 1,3-bis(tert-butylperoxyisopropyl)benzene, and the like.

In some embodiments, the oxidizer is a nitrogen-chloro oxidizer that contains a nitrogen-chlorine bond that is readily released in the oilfield waste water. Exemplary nitrogen-chloro oxidizers are inorganic and organic chloramines (R₂NCl, wherein R is independently hydrogen, alkyl, alkylene, and the like) and chlorinated triazine or a derivative thereof that oxidizes sulfide to water soluble sulfate. Such compounds include, e.g., chlorinated oxytriazines, hydroxytriazines, melamines, guanamines, halotriazines, haloalkyltriazines, cyaphenine, and the like. An exemplary compound is trichloro-s-triazinetrione.

According to an embodiment, a coagulant or flocculant is added to clarify the oilfield waste water such as after oxidation of the sulfide. The coagulant is nonionic, cationic, anionic, or zwitterionic. Likewise, the flocculant is nonionic, cationic, anionic, or zwitterionic. According to an embodiment, the coagulant and flocculant are disposed in the oilfield waste water separately or together.

In some embodiments, the precipitate is contacted by the flocculant, coagulant, or a combination thereof to form an aggregate precipitate. The flocculant or coagulant is added to the oilfield waste water before, after, or during addition of the hydrogen peroxide. Furthermore, the flocculant and coagulant are introduced in the oilfield waste water coincidentally or asynchronously. Without wishing to be bound by theory, it is believed that the flocculant or coagulant accumulates a plurality of precipitate particles to form a large mass of insoluble material with respect to the oilfield waste water. In an embodiment, the flocculant bridges precipitate particles, resulting in more efficient settling.

In an embodiment, the coagulant is an inorganic salt (e.g., sodium chloride, aluminum sulfate, polyaluminum chloride, ferric sulfate, ferric chloride, aluminum chloride, sodium aluminate, and the like), organic polymer (e.g., polyethyleneimine, dimethylamine-epichlorohydrin copolymer, dicyandiamide-formaldehyde condensation product, cation-modified starch, and the like), tannin, a melamine formaldehyde, a resin amine, or a combination comprising at least one of the foregoing.

The flocculant is a cationic flocculant, a non-ionic flocculant, or an anionic flocculant. Additionally, the flocculant is present as an emulsion, a dispersion, a brine dispersion, and the like. In an embodiment, the flocculant is an emulsion, which includes a copolymer of acrylamide (ACM) and acrylic acid (AA), a copolymer of acrylamide (ACM) and dimethylaminoethyl acrylate (ADAME), N,N-dimethylaminoethyl acrylate methyl chloride quaternary (AETAC, also referred to as Q9), cationic polyacrylamide (EPAM), acrylic acid (AA), ACM, acrylamide (AM), meth acrylic acid (MA), and the like.

In an embodiment, a cationic coagulant is an inorganic coagulant such as an aluminum compound (e.g., aluminum chloride). According to an embodiment, a cationic polymeric coagulant or flocculant is a polyethylene imine or polyamine (which is or is not fully quaternized), a dicyandiamide condensation polymer (which is substantially fully quaternized or in salt form), a polymer of water soluble ethylenically unsaturated monomer or monomer blend that is formed from 50 mole percent (mol %) to 100 mol % cationic monomer and from 0 mol % to 50 mol % of another monomer. Ethylenically unsaturated cationic monomers include dialkylaminoalkyl(meth)-acrylates and dialkylaminoalkyl(meth)acrylamides (usually in quaternary or salt form), diallyl dialkyl ammonium chloride (e.g., diallyl dimethyl ammonium chloride (DADMAC), and the like. Cationic homopolymers or copolymers are useful. In an embodiment, the polymer is a copolymer, and the co-monomer is acrylamide or another water soluble non-ionic ethylenically unsaturated monomer.

According to an embodiment, the cationic polymeric coagulant is a linear polymer. Alternatively, it is produced from multifunctional monomers or additives that produce a branched structure in the polymer backbone, for instance polyethylenically unsaturated monomers such as tetraallyl ammonium chloride, methylene bis acrylamide, and the like.

Nonionic coagulants or flocculants are prepared from nonionic monomers such as acrylamide, methacrylamide, N-methylacrylamide, N,N-dimethyl(meth)acrylamide, N-isopropyl(meth)acrylamide, N-(2-hydroxypropyl)methacrylamide, N-methylolacrylamide, N-vinylformamide, N-vinylacetamide, N-vinyl-N-methylacetamide, poly(ethylene glycol)(meth)acrylate, poly(ethylene glycol)monomethyl ether mono(meth)acrylate, N-vinyl-2-pyrrolidone, glycerol mono((meth)acrylate), 2-hydroxyethyl(meth)acrylate, vinyl methylsulfone, vinyl acetate, and the like.

Zwitterionic coagulants of flocculants are prepared from monomers containing cationic and anionic functionality in equal charge proportions so that the zwitterionic polymer is net neutral. Exemplary zwitterionic monomers include N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine (MPC), 2-[(3-acrylamidopropyl)dimethylammonio]ethyl 2′-isopropyl phosphate (AAPI), 1-vinyl-3-(3-sulfopropyl)imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N,N-diallylamine ammonium betaine (MDABS), N,N-diallyl-N-methyl-N-(2-sulfoethyl) ammonium betaine, and the like.

In an embodiment, the flocculant or coagulant is anionic and is an anionic polymer that includes repeat units that are anionic, cationic, neutral, or a combination thereof such that the polymer has a net negative charge. The repeat units are branched or linear. In an embodiment, the anionic polymer includes repeat units having various anionic functional groups (e.g., carboxylic acid, sulfonic acid, phosphoric acid, or a phosphonic acid functional group, specifically carboxylic acid radicals) alone or together with further polar radicals such as carboxamide radicals. Anionic copolymer flocculants or coagulants are obtained by copolymerizing an ethylenically unsaturated monomer having an anionic or anionizable side group (e.g., acrylic, methacrylic, vinylsulfonic, vinylphosphonic, itaconic and 2-acrylamidomethylpropanesulfonic acid, sulfopropyl acrylate and sulfopropyl methacrylate) with a nonionic comonomer (e.g., acrylamide, methacrylamide, N-vinylformamide, N-vinylacetamide, N-vinylmethylacetamide, N-vinylmethylformamide, vinyl acetate, vinylpyrrolidone, and the like). Further, anionic functional groups are introduced into the polymer by esterifying carboxyl groups with a polyol, such as ethanediol, and subjecting the remaining free hydroxyl groups to further reaction with, for example, sulfuric acid or phosphoric acid. In an embodiment, the anionic polymer includes acrylamide and acrylic acid prepared by polymerization of acrylamide and acrylic acid or through hydrolysis of polyacrylamide, e.g., partially hydrolyzed polyacrylamide.

Exemplary monomer units that are polymerized to form the anionic polymer are acrylamide, (meth)acrylamide, 2-acrylamido-2-methylpropane sulphonic acid, acrylamido propyltrimethyl ammonium chloride, acrylic acid, acrylic acid esters, dimethyldiallylammonium chloride, dimethylaminoethyl acrylate, dimethylaminoethyl methacrylate, isopropyl acrylamide, polyethylene glycol methacrylate, itaconic acid, methacrylamido propyltrimethyl ammonium chloride, methacrylic acid, methacrylic acid esters, N-vinyl acetamide, N-vinyl formamide N-vinyl pyrrolidone, N-vinylimidazole, N-vinylpyridine, vinyl sulfonic acid, N,N-dimethylacrylamide, tert-butyl acrylamide, poly(ethylene glycol) methyl ether acrylate, poly(propylene glycol) methyl ether acrylate, poly(ethylene glycol) acrylate, undecanoic acid, lauryl acrylate, (3-acrylamidopropyl)trimethylammonium chloride, N-(hydroxymethyl)acrylamide, N-(hydroxyethyl)acrylamide, 2-acrylamidoglycolic acid, 3-acryloylamino-1-propanol, N-(isobutoxymethyl)acrylamide, N-[tris(hydroxymethyl)methyl]acrylamide, N-phenylacrylamide, 2-(diethylamino)ethyl acrylate, 2-ethylhexyl acrylate, 2-hydroxyethyl acrylate, 3-(dimethylamino)propyl acrylate, 4-hydroxybutyl acrylate, di(ethylene glycol) 2-ethylhexyl ether acrylate, [2-(acryloyloxy)ethyl]trimethylammonium chloride, sodium acrylate, 2-(diethylamino)ethyl methacrylate, 2-(dimethylamino)ethyl methacrylate, 2-butoxyethyl methacrylate, 3-(acryloyloxy)-2-hydroxypropyl methacrylate, and the like. In a particular embodiment, the anionic polymer is made by copolymerizing (meth)acrylamide and (meth)acrylic acid.

Examples of anionic polymers include polyacrylic acid, polyacrylates, poly((meth)acrylates), acrylamide/sodium acrylate copolymers, acrylamide/sodium(meth)acrylate copolymers, acrylamide/acrylamidomethyl propone sulfonic acid copolymers, terpolymers of acrylamide/acrylamidomethyl propone sulfonic acid/sodium acrylate, and the like. According to an embodiment, the anionic polymer is a copolymer comprising acrylamide and acrylic acid (or an acrylate salt). In an embodiment, the flocculant is a copolymer that includes acrylamide and acrylate repeat units. Such a flocculant copolymer is available under the trade name Spectrafloc 875 from Baker Hughes Inc. or the trade name Tramfloc 100-199 from Tramfloc Inc.

According to an embodiment, the acrylamide and acrylic acid are present in the anionic polymer in any relative amount. In some embodiments, the acrylamide is present in an amount from 5% to 95% and acrylic acid in an amount from 5% to 95%, based on the total moles of repeat units in the anionic polymer. A ratio of the anionic repeat units to nonionic and cationic repeat units in the anionic copolymer is greater than or equal to 0.1, specifically greater than or equal to 1, more specifically greater than or equal to 10, even more specifically greater than or equal to 100, yet more specifically greater than or equal to 1,000, and further specifically greater than or equal to 10,000, provided that the net charge of the anionic polymer is negative.

It is contemplated that the sulfide in the oilfield waste water is a number of different forms or species. In an embodiment, the sulfide includes an inorganic sulfide such as hydrogen sulfide (H₂S), bisulfide (HS⁻), sulfide ion (S²⁻), or a combination comprising at least one of the foregoing. The form and amount of the inorganic sulfide depends on pH. That is, hydrogen sulfide is a dominant species at an acidic pH (e.g., pH less than 6); bisulfide dominates at pH from 7 to 9, and sulfide ion (S²⁻) has the greatest concentration at an alkaline pH greater than 9. According to an embodiment, the sulfide is a metal sulfide such as CdS, Ag₂S, FeS, and the like. In some embodiments, the sulfide is an alkali metal sulfide such as Li₂S, Na₂S, K₂S, and the like. In an embodiment, the sulfide is an organic sulfide such as a thioether, thiol, and the like.

In an embodiment, an additive is added to the oilfield waste water after oxidation of the sulfide to sulfur in forming the treated water such that the treated water is useful as a hydraulic fracturing fluid or in enhanced oil production methods. The additive includes an acid (e.g., a mineral acid or organic acid), a biocide, a polymer, a breaker, a clay stabilizer, a corrosion inhibitor, a crosslinker, a friction reducer, a gelling agent, an iron control agent, a lubricant, a non-emulsifier, a pH-adjusting agent, a scale inhibitor, a surfactant, a proppant, or a combination comprising at least one of the foregoing. Such additives are thought to, for example, facilitate entry into rock formations, kill bacteria and reduce the risk of fouling, stabilize clay, provide well maintenance, facilitate proppant entry, improve surface pressure, provide proppant placement, prevent precipitation, and reduce fluid tension of the composition.

Useful surfactants include fatty acids of up to 22 carbon atoms such as stearic acids and esters and polyesters thereof, poly(alkylene glycols) such as poly(ethylene oxide), poly(propylene oxide), and block and random poly(ethylene oxide-propylene oxide) copolymers such as those marketed under the trademark PLURONIC by BASF. Other surfactants include polysiloxanes, such as homopolymers or copolymers of poly(dimethylsiloxane), including those having functionalized end groups, and the like. Other useful surfactants include those having a polymeric dispersant having poly(alkylene glycol) side chains, fatty acids, or fluorinated groups such as perfluorinated C₁₋₄ sulfonic acids grafted to the polymer backbone. Polymer backbones include those based on a polyester, a poly(meth)acrylate, a polystyrene, a poly(styrene-(meth)acrylate), a polycarbonate, a polyamide, a polyimide, a polyurethane, a polyvinyl alcohol, or a copolymer comprising at least one of these polymeric backbones. Additionally, the surfactant is anionic, cationic, zwitterionic, or non-ionic.

Exemplary cationic surfactants include but are not limited to alkyl primary, secondary, and tertiary amines, alkanolamides, quaternary ammonium salts, alkylated imidazolium, and pyridinium salts. Additional examples of the cationic surfactant include primary to tertiary alkylamine salts such as, e.g., monostearylammonium chloride, distearylammonium chloride, tristearylammonium chloride; quaternary alkylammonium salts such as, e.g., monostearyltrimethylammonium chloride, distearyldimethylammonium chloride, stearyldimethylbenzylammonium chloride, monostearyl-bis(polyethoxy)methylammonium chloride; alkylpyridinium salts such as, e.g., N-cetylpyridinium chloride, N-stearylpyridinium chloride; N,N-dialkylmorpholinium salts; fatty acid amide salts such as, e.g., polyethylene polyamine; and the like.

Exemplary anionic surfactants include alkyl sulfates, alkyl sulfonates, fatty acids, sulfosuccinates, and phosphates. Examples of an anionic surfactant include anionic surfactants having a carboxyl group such as sodium salt of alkylcarboxylic acid, potassium salt of alkylcarboxylic acid, ammonium salt of alkylcarboxylic acid, sodium salt of alkylbenzenecarboxylic acid, potassium salt of alkylbenzenecarboxylic acid, ammonium salt of alkylbenzenecarboxylic acid, sodium salt of polyoxyalkylene alkyl ether carboxylic acid, potassium salt of polyoxyalkylene alkyl ether carboxylic acid, ammonium salt of polyoxyalkylene alkyl ether carboxylic acid, sodium salt of N-acylsarcosine acid, potassium salt of N-acylsarcosine acid, ammonium salt of N-acylsarcosine acid, sodium salt of N-acylglutamic acid, potassium salt of N-acylglutamic acid, ammonium salt of N-acylglutamic acid; anionic surfactants having a sulfonic acid group; anionic surfactants having a phosphonic acid; and the like.

In an embodiment, the nonionic surfactant is, e.g., an ethoxylated fatty alcohols, alkyl phenol polyethoxylates, fatty acid esters, glycerol esters, glycol esters, polyethers, alkyl polyglycosides, amineoxides, or a combination thereof. Exemplary nonionic surfactants include fatty alcohols (e.g., cetyl alcohol, stearyl alcohol, cetostearyl alcohol, oleyl alcohol, and the like); polyoxyethylene glycol alkyl ethers (e.g., octaethylene glycol monododecyl ether, pentaethylene glycol monododecyl ether, and the like); polyoxypropylene glycol alkyl ethers (e.g., butapropylene glycol monononyl ethers); glucoside alkyl ethers (e.g., decyl glucoside, lauryl glucoside, octyl glucoside); polyoxyethylene glycol octylphenol ethers (e.g., Triton X-100 (octyl phenol ethoxylate)); polyoxyethylene glycol alkylphenol ethers (e.g., nonoxynol-9); glycerol alkyl esters (e.g., glyceryl laurate); polyoxyethylene glycol sorbitan alkyl esters (e.g., polysorbates such as sorbitan monolaurate, sorbitan monopalmitate, sorbitan monostearate, sorbitan tristearate, sorbitan monooleate, and the like); sorbitan alkyl esters (e.g., polyoxyethylene sorbitan monolaurate, polyoxyethylene sorbitan monopalmitate, polyoxyethylene sorbitan monostearate, polyoxyethylene sorbitan monooleate, and the like); cocamide ethanolamines (e.g., cocamide monoethanolamine, cocamide diethanolamine, and the like); amine oxides (e.g., dodecyldimethylamine oxide, tetradecyldimethylamine oxide, hexadecyl dimethylamine oxide, octadecylamine oxide, and the like); block copolymers of polyethylene glycol and polypropylene glycol (e.g., poloxamers available under the trade name Pluronics, available from BASF); polyethoxylated amines (e.g., polyethoxylated tallow amine); polyoxyethylene alkyl ethers such as polyoxyethylene stearyl ether; polyoxyethylene alkylene ethers such as polyoxyethylene oleyl ether; polyoxyalkylene alkylphenyl ethers such as polyoxyethylene nonylphenyl ether; polyoxyalkylene glycols such as polyoxypropylene polyoxyethylene glycol; polyoxyethylene monoalkylates such as polyoxyethylene monostearate; bispolyoxyethylene alkylamines such as bispolyoxyethylene stearylamine; bispolyoxyethylene alkylamides such as bispolyoxyethylene stearylamide; alkylamine oxides such as N,N-dimethylallylamine oxide; and the like.

Zwitterionic surfactants (which include a cationic and anionic functional group on the same molecule) include, e.g., betaines, such as alkyl ammonium carboxylates (e.g., [(CH₃)₃N⁺—CH(R)COO⁻] or sulfonates (sulfo-betaines) such as [RN⁺(CH₃)₂(CH₂)₃SO₃₋], where R is an alkyl group). Examples include n-dodecyl-N-benzyl-N-methylglycine [C₁₂H₂₅N⁻(CH₂C₆H₅)(CH₃)CH₂COO⁻], N-allyl N-benzyl N-methyltaurines [CₙH₂ₙ₊₁N⁺(CH₂C₆H₅)(CH₃)CH₂CH₂SO₃⁻].

In an embodiment, a non-emulsifier of the additive is a combination of the above surfactants or a combination of surfactant with a short chain alcohol or polyol such as lauryl sulfate with isopropanol or ethylene glycol. The non-emulsifier prevents formation of emulsions in the treated water, e.g., hydraulic fracturing fluid.

In an embodiment, the additive is a lubricant such as a polyacrylamide, petroleum distillate, hydrotreated light petroleum distillate, a short chain alcohol (e.g., methanol), or polyol (e.g., ethylene glycol). Such lubricants minimize friction and also include, e.g., a polymer such as polyacrylamide, polyisobutyl methacrylate, polymethyl methacrylate, or polyisobutylene as well as water-soluble lubricants such as guar, guar derivatives, polyacrylamide, and polyethylene oxide.

A clay stabilizer of the additive prevents the clay downhole from swelling under contact with the treated water (e.g., hydraulic fracturing fluid) or applied fracturing pressure. In an embodiment, the clay stabilizer includes a quaternary amine, a brine (e.g., KCl brine), choline chloride, tetramethyl ammonium chloride, and the like.

According to an embodiment, the additive is a pH-adjusting agent, which adjusts the pH of the treated water. The pH-adjusting agent is an organic or inorganic base, organic or inorganic acid, or a buffer, which is any appropriate combination of acid and conjugate base. Exemplary inorganic bases include those represented by MOH, where M is a metal from group 1 or 2 of the periodic table, a transition metal, or a metal or metalloid from group 13, 14, or 15; carbonate salt; bicarbonate salt; or a combination thereof. Exemplary inorganic acids include HCl, HBr, fluoroboric acid, sulfuric acid, nitric acid, acetic acid, formic acid, methanesulfonic acid, propionic acid, chloroacetic or dichloroacetic acid, citric acid, glycolic acid, lactic acid, or a combination thereof. In an embodiment, the pH-adjusting agent is selected to impart favorable characteristics to the treated water, particularly the hydraulic fracturing fluid. In an embodiment, the pH-adjusting agent is selected to avoid damage to the surface equipment or to avoid damaging the wellbore or subterranean formation.

In an embodiment, the additive is a biocide that prevents injection of a microbe (e.g., bacteria) downhole. Further, after injection of the treated water downhole, the biocide in the treated water eliminates or reduces microbes present in the downhole environment. The biocide kills, eliminates, or reduces bacteria in the treated water including additional added water (e.g., when using river water to include in the treated water). In this way, introduction of live bacteria into the formation is prevented, thus reducing production of, e.g., sour gas.

According to an embodiment, the biocide does not interfere with the other components of the treated water formed and is not a health risk. In an embodiment, the biocide is an aldehyde such as glutaraldehyde, o-phthalaldehyde, formaldehyde, and the like. Examples of the secondary biocide include non-oxidizing and oxidizing secondary biocides. Exemplary oxidizing biocides include hypochlorite bleach (e.g., calcium hypochlorite and lithium hypochlorite), peracetic acid, potassium monopersulfate, potassium peroxymonosulfate, bromochlorodimethylhydantoin, dichloroethylmethylhydantoin, chloroisocyanurate, tris hydroxymethyl phosphine, trichloroisocyanuric acids, dichloroisocyanuric acids, 1-(3-chloroallyl)-3,5,7-triaza-1-azonia-adamantane chloride, 1,2-benzisothiazolin-3-one, chlorinated hydantoins, and the like. Additional oxidizing biocides include, e.g., bromine products such as: sodium hypobromite, ammonium bromide, sodium bromide, or brominated hydantoins such as 1-bromo-3-chloro-5,5-dimethylhydantoin. Other oxidizing biocides include chlorine, chlorine dioxide, chloramine, ozone, inorganic persulfates such as ammonium persulfate, or peroxides, such as hydrogen peroxide and organic peroxides.

Exemplary non-oxidizing biocides include dibromonitfilopropionamide, thiocyanomethylthiobenzothlazole, methyldithiocarbamate, tetrahydrodimethylthladiazonethione, tributyltin oxide, bromonitropropanediol, bromonitrostyrene, methylene bisthiocyanate, chloromethylisothlazolone, methylisothiazolone, benzisothlazolone, dodecylguanidine hydrochloride, polyhexamethylene biguanide, tetrakis(hydroxymethyl)phosphonium sulfate, glutaraldehyde, alkyldimethylbenzyl ammonium chloride, didecyldimethylammonium chloride, poly[oxyethylene-(dimethyliminio)ethylene (dimethyliminio)ethylene dichloride], decylthioethanamine, terbuthylazine, and the like. Additional non-oxidizing biocides are quaternary ammonium salts, aldehydes, and quaternary phosphonium salts. In an embodiment, quaternary biocides have a fatty alkyl group and three methyl groups, but in the phosphonium salts, the methyl groups, e.g., are substituted by hydroxymethyl groups without substantially affecting the biocidal activity. In an embodiment, they also are substituted with an aryl group. Further examples include formaldehyde, glyoxal, furfural, acrolein, methacrolein, propionaldehyde, acetaldehyde, crotonaldehyde, pyridinium biocides, benzalkonium chloride, cetrimide, cetyl trimethyl ammonium chloride, benzethonium chloride, cetylpyridinium chloride, chlorphenoctium amsonate, dequalinium acetate, dequalinium chloride, domiphen bromide, laurolinium acetate, methylbenzethonium chloride, myristyl-gamma-picolinium chloride, octaphonium chloride, triclobisonium chloride, alkyl dimethyl benzyl ammonium chloride, cocodiamine, dazomet, 1-(3-chloroallyl)-chloride.3,5,7-triaza-1-azoniaadamantane, or a combination thereof.

Additional exemplary biocides include triazines such as and 1,3,5-tris-(2-hydroxyethyl)-s-triazine trimethyl-1,3,5-triazine-1,3,5-triethanol, iodopropynylbutylcarbamate, 4,4-dimethyloxazolide, 7-ethyl bicyclooxazolidine, 4-(2-nitrobutyl)-morpholine, 4,4′-(2-ethyl-2-nitrotrimethylene)dimorpholine, octylisothiazolinone, dichloro-octylisothiazolinone, dibromo-octylisothiazolinone, phenolics (e.g., o-phenylphenol, p-chloro-m-cresol, their corresponding alkali metal salt, and the like), sodium pyrithione, zinc pyrithione, n-butyl benzisothiazolinone, 1-(3-chloroallyl)-3,5,7-triaza-1-azoniaadamantane chloride, chlorothalonil, carbendazim, diiodomethyltolylsulfone, N,N′-methylene-bis-morpholine, ethylenedioxy methanol, phenoxyethanol, tetramethylol acetylenediurea, dithiocarbamates, 2,6-dimethyl-m-dioxan-4-ol acetate, dimethylol-dimethylhydantoin, bicyclic oxazolidines, (thiocyanomethylthio)-benzothiazole, and the like.

Further exemplary biocides are 3-allyloxy-1,2-benzoisothiazol-1,1-dioxide; methyl-N-(1H-benzoimidazol-2-yl) carbamate; 2-(tert-butylamino)-4-(cyclopropylamino)-6-(methylthio)-striazine; 2-tert-butylamino-4-ethylamino-6-methylmercapto-s-triazine; 2-chloro-1-(3-ethoxy-4-nitrophenoxy)-4(trifluoromethyl)benzene; 4-chlorophenoxy-3,3-dimethyl-1-(1H,1,3,4-triazol-1-yl)-2-butanone; α-[2-(4-chlorophenyl)ethyl]-α-(1,1-dimethylethyl)-1H-1,2,4-triazole-1-ethanol; copper 8-quinolinate; cycloheximide; bis-(dimethyldithiocarbamyl)disulfide; 1,4-dichloro-2,5-dimethoxybenzene; N′-dichlorofluoromethylthio-N,N-dimethyl-N-phenyl sulfamide; 2,3-dichloro-1,4-naphthoquinone; 2,6-dichloro-4-nitroaniline; 4,5-dichloro-2-N-octyl-4-isothiazolin-3-one; N-(3,5-dichlorophenyl)-1,2-dimethylcyclopropane-1,2-dicarboxylmide; N′-(3,4-dichlorophenyl)-N,N-dimethylurea; 1-[2-(2,4-dichlorophenyl)-4-ethyl-1,3-dioxorane methyl]-1H,1,2,4-triazol; N-(3,5-dichlorophenyl)succinamide; 1-[[2(2,4-dichlorophenyl)-4-propyl-1,3-dioxolan-2-yl]methyl]-1-H-1,2,4-triazole; N-2,3-dichlorophenyltetrachlorophthalamic acid; 3-(3,5-dichlorophenyl)-5-ethenyl-5-methyloxazolidine-2,4-dione; 2,3-dicyano-1,4-dithiaanthraquinone; N-(2,6-diethylphenyl)-4-methylphthalimide; N-(2,6-p-diethylphenyl)phthalimide; 5,6-dihydro-2-methyl-1,4-oxathine-3-carboxanilide; 5,6-dihydro-2-methyl-1,4-oxathine-3-carboxanido-4,4-dioxide; diisopropyl 1,3-dithiolane-2-iridene malonate; N,N-diisopropyl S-benzylphosphorothioate; 2-dimethylamino-4-methyl-5-N-butyl-6hydroxypyrimidine; diethyl 2-dimethoxyphosphinothioylsulfanylbutanedioate; bis(dimethyldithiocarbamyl)ethylenediamine; 5-ethoxy-3-trichloromethyl-1,2,4-thiaziazole; ethyl-N-(3-dimethylaminopropyl)thiocarbamate hydrochloride; 3,3′-ethylene-bis-(tetrahydro-4,6-dimethyl-2H-1,3,5-thiadiazine-2thione); 3-hydroxy-5-methylisoxazole; 3-iodo-2-propargyl butyl carbamate; iron methanearsonate; 3′-isopropoxy-2-methylbenzanilide; 1-isopropylcarbamoyl-3-(3,5-dichlorophenyl) hydantoin; manganese ethylene-bis-(dithiocarbamate); 1,2-bis-(3-methoxycarbonyl-2-thioureido)benzene; methyl-1(butylcarbamoyl)-2-benzimidazolecarbamate, 3-methyl-4-chlorobenzothiazol-2-one; nickel dimethyldithiocarbamate; 2-octyl-2H-isothiazol-3-one; 2-oxy-3-chloro-1,4-naphthoquinone copper sulfate; pentachloronitrobenzene; potassium N-hydroxymethyl-N-methyldithiocarbamate; N-propyl-N-[2-(2,4,6-trichlorophenoxy)ethyl]imidazol-1-carboxamide; 2-pyridinethiol-1-oxide sodium salt; sodium pyrithione; N-tetrachloroethylthio-4-cyclohexene-1,2-dicarboxylmide; tetrachloroisophthalonitrile; 4,5,6,7-tetrachlorophthalide; 2-(thiocyanomethylthio)benzothiazole; N-trichloromethylthio 4-cyclohexene-1,2-dicarboxylmide; N-(trichloromethylthio)phthalimide; validamycin; zinc ethylene-bis-(dithiocarbamate); zinc bis-(1-hydroxy-2(1H)pyridinethionate; zinc propylene-bis-(dithiocarbamate); zinc pyrithione, and the like. A combination of any of the foregoing biocides is useful together as long as the combination does not negatively affect reuse of the treated water or render the biocide inactive or substantially inactive with respect to reducing or eliminating the bacteria in the oilfield waste water.

In one embodiment, the oilfield waste water is irradiated with, e.g., an ultraviolet, a visible, or an infrared wavelength, which further eliminates bacteria in the oilfield waste water. According to an embodiment, the oilfield waste water is heated to decrease the number density of bacteria therein. Irradiating or heating the oilfield waste water occurs synchronously or asynchronously combining the oilfield waste water with the biocide. In the asynchronous case, irradiating or heating the oilfield waste water occurs before or after combining the oilfield waste water with the biocide.

In an embodiment, the biocide is encapsulated or coated by any suitable encapsulation method using any suitable encapsulation material. The encapsulation material is any material that does not adversely interact or chemically react with the biocide to destroy its utility. In an embodiment, the biocide is released from the coating at a selected time.

In an embodiment, the additive is hydrochloric acid, glutaraldehyde, 2,2-dibromo-3-nitrilopropionamide, peroxodisulfates, salt (for example, tetramethylammonium chloride), methanol, potassium hydroxide, sodium acrylate, polyacrylamide, guar gum, citric acid, thioglycolic acid, ethylene glycol, polyacrylate, isopropanol, or a combination thereof.

According to an embodiment, the additive is a breaker such as a peroxide, a persulfate, a perphosphate, a perborate, a percarbonate, a persilicate, an oxyacid of a halogen, an oxyanion of halogen, a peracid, a derivative thereof, or a combination thereof. In some embodiments, the oxidizer and the breaker are the same or different.

In one embodiment, the breaker is a persulfate, such as sodium persulfate, ammonium persulfate, potassium persulfate, potassium peroxymonosulfate (Caro's acid), or a combination thereof. The breaker is, e.g., an oxyacid or oxyanion of halogen, for instance, hypochlorous acid, a hypochlorite, chlorous acid and chlorites, chloric acid and chlorates, perchloric acid and perchlorate, a derivative thereof, or a combination thereof.

In an embodiment, a peroxide breaker has oxygen-oxygen single bonds in its molecular structure. The peroxide breaker is hydrogen peroxide or another material to provide peroxide or hydrogen peroxide so that the breaker has a breaking function, such as changing fluid viscosity. Metal peroxides such as sodium peroxide, calcium peroxide, zinc peroxide, magnesium peroxide, or other peroxides such as superoxides, organic peroxides, and the like can be used.

Additionally, in an embodiment, the peroxide breaker is a stabilized peroxide breaker with the hydrogen peroxide bound, inhibited, or the like by another compound or molecule prior to contact with, e.g., an aqueous fluid such as water such that it forms or releases hydrogen peroxide when contacted by the aqueous fluid. Exemplary stabilized peroxide breakers include an adduct of hydrogen peroxide with another molecule and include carbamide peroxide or urea peroxide (C(═O)(NH2)₂.H₂O₂), a percarbonate (e.g., sodium percarbonate (2Na₂CO₃.3H₂O₂), potassium percarbonate, ammonium percarbonate, and the like), and the like. The stabilized peroxide breakers also include compounds that undergo hydrolysis in water to release hydrogen peroxide, e.g., sodium perborate. In an embodiment, hydrogen peroxide stabilized with appropriate surfactants also is used as the stabilized peroxide breaker. In some embodiments, the hydrogen peroxide used to oxidize the sulfide to sulfur is encapsulated as above described.

According to an embodiment, the breaker is the peracid, e.g., peracetic acid, perbenzoic acid, a derivative thereof, or a combination thereof. Additionally, a variety of peroxycarboxylic acids is employed as the peracid breaker. The peroxycarboxylic acid includes an ester peroxycarboxylic acid, an alkyl ester peroxycarboxylic acid, a sulfoperoxycarboxylic acid, or a combination thereof. Peroxycarboxylic acid (or percarboxylic acid) are acids having a general formula R(CO₃H)ₙ. In an embodiment, the R group is saturated or unsaturated as well as substituted or unsubstituted. As described herein, R is an alkyl, alkenyl, arylalkyl, arylalkenyl, cycloalkyl, cycloalkenyl, aromatic, heterocyclic, or ester group, or a combination thereof (e.g., an alkyl ester group), with n being 1, 2, or 3. Exemplary ester groups include aliphatic ester groups, such as R¹OC(O)R², where R¹ and R² independently are a group (e.g., an alkyl group) described above for R such that R¹ and R² are, e.g., independently small carbon chain alkyl groups, such as a C₁-C₅ alkyl group.

One skilled in the art will appreciate that peroxycarboxylic acids may not be as stable as carboxylic acids, and their stability may increase with increasing molecular weight. Thermal decomposition of the peracids proceeds by, e.g., free radical and nonradical paths, by photodecomposition or radical-induced decomposition, or by the action of metal ions or complexes. In an embodiment, the percarboxylic acid peracids are made by direct, acid catalyzed equilibrium action of hydrogen peroxide with a carboxylic acid, by autoxidation of aldehydes, or from acid chlorides, and hydrides, or carboxylic anhydrides with hydrogen or sodium peroxide.

Exemplary peroxycarboxylic acids include peroxyformic, peroxyacetic, peroxypropionic, peroxybutanoic, peroxypentanoic, peroxyhexanoic, peroxyheptanoic, peroxyoctanoic, peroxynonanoic, peroxydecanoic, peroxyundecanoic, peroxydodecanoic, peroxylactic, peroxycitric, peroxymaleic, peroxyascorbic, peroxyhydroxyacetic (peroxyglycolic), peroxyoxalic, peroxymalonic, peroxysuccinic, peroxyglutaric, peroxyadipic, peroxypimelic, peroxysuberic, peroxysebacic acid, and the like.

In an embodiment, the peracid includes a combination of several peroxycarboxylic acids. According to one embodiment, the composition includes a C₂-C₄ peroxycarboxylic acid, a C₈-C₁₂ peroxycarboxylic acid, an ester peroxycarboxylic acid, an alkyl ester peroxycarboxylic acids, or a mono- or di-peroxycarboxylic acid having up to 12 carbon atoms, and more specifically 2 to 12 carbon atoms. In an embodiment, the peroxycarboxylic acid includes peroxyacetic acid (POAA) (i.e., peracetic acid having the formula CH₃COOOH) or peroxyoctanoic acid (POOA) (i.e., peroctanoic acid having the formula, e.g., of n-peroxyoctanoic acid: CH₃(CH₂)₆COOOH).

In an embodiment, the peracid is an ester peroxycarboxylic acid. As used herein, ester peroxycarboxylic acid refers to a molecule having the formula:

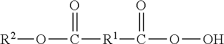

wherein R¹ and R² are independently an organic group (e.g., alkyl, linear or cyclic, aromatic or saturated) or a substituted organic group (e.g., with a heteroatom or organic group). In an embodiment, the ester peroxycarboxylic acid is made by employing methods used for making peroxycarboxylic acid such as combining the corresponding ester carboxylic acid with an oxidizing agent, e.g., hydrogen peroxide.

Exemplary alkyl esterperoxycarboxylic acids include monomethyl monoperoxyglutaric acid, monomethyl monoperoxyadipic acid, monomethyl monoperoxyoxalic acid, monomethyl monoperoxymalonic acid, monomethyl monoperoxysuccinic acid, monomethyl monoperoxypimelic acid, monomethyl monoperoxysuberic acid, monomethyl monoperoxysebacic acid; monoethyl monoperoxyoxalic acid, monoethyl monoperoxymalonic acid, monoethyl monoperoxysuccinic acid, monoethyl monoperoxyglutaric acid, monoethyl monoperoxyadipic acid, monoethyl monoperoxypimelic acid, monoethyl monoperoxysuberic acid, monoethyl monoperoxysebacic acid; monopropyl monoperoxyoxalic acid, monopropyl monoperoxymalonic acid, monopropyl monoperoxysuccinic acid, monopropyl monoperoxyglutaric acid, monopropyl monoperoxyadipic acid, monopropyl monoperoxypimelic acid, monopropyl monoperoxysuberic acid, monopropyl monoperoxysebacic acid, in which propyl is n- or isopropyl; monobutyl monoperoxyoxalic acid, monobutyl monoperoxymalonic acid, monobutyl monoperoxysuccinic acid, monobutyl monoperoxyglutaric acid, monobutyl monoperoxyadipic acid, monobutyl monoperoxypimelic acid, monobutyl monoperoxysuberic acid, monobutyl monoperoxysebacic acid, in which butyl is n-, iso-, or t-butyl; and the like.

In some embodiments, the peracid breaker is a sulfoperoxycarboxylic acid. Sulfoperoxycarboxylic acids, which also are referred to as sulfonated peracids, include the peroxycarboxylic acid form of a sulfonated carboxylic acid. In some embodiments, the sulfonated peracid is a mid-chain sulfonated peracid, i.e., a peracid that includes a sulfonate group attached to a carbon that is at least one carbon (e.g., at least the three position) from the carbon of the percarboxylic acid group in the carbon backbone of the percarboxylic acid chain, wherein at least one carbon is not in the terminal position. As used herein, the term “terminal position” refers to the carbon on the carbon backbone chain of a percarboxylic acid that is furthest from the percarboxyl group. Thus, in an embodiment, sulfoperoxycarboxylic acid has the following formula:

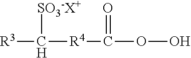

wherein R³ is hydrogen or a substituted or unsubstituted alkyl group; R⁴ is a substituted or unsubstituted alkyl group; X is hydrogen, a cationic group, or an ester forming moiety; or salts or esters thereof.

In some embodiments, R³ is a substituted or unsubstituted Cₘ alkyl group; X is hydrogen, a cationic group, or an ester forming moiety; R⁴ is a substituted or unsubstituted Cₙ alkyl group; m=1 to 10; n=1 to 10; and m+n is less than 18; or salts, esters, or a combination thereof. In some embodiments, R³ is hydrogen. In other embodiments, R³ is a substituted or unsubstituted alkyl group. In some embodiments, R³ is a substituted or unsubstituted alkyl group that does not include a cycloalkyl group. In some embodiments, R³ is a substituted alkyl group. In some embodiments, R³ is an unsubstituted C₁-C₉ alkyl group. In some embodiments, R³ is an unsubstituted C₇ or C₈ alkyl. In other embodiments, R³ is a substituted C₈-C₁₀ alkyl group. In some embodiments, R³ is a substituted C₈-C₁₀ alkyl group and is substituted with at least 1, or at least 2 hydroxyl groups. In still yet other embodiments, R³ is a substituted C₁-C₉ alkyl group. In some embodiments, R³₁ is a substituted C₁-C₉ substituted alkyl group and is substituted with an —SO₃H group. In other embodiments, R³ is a C₉-C₁₀ substituted alkyl group. In some embodiments, R³ is a substituted C₉-C₁₀ alkyl group wherein at least two of the carbons on the carbon backbone form a heterocyclic group. In some embodiments, the heterocyclic group is an epoxide group.

In an embodiment, R⁴ is a substituted C₁-C₁₀ alkyl group. In some embodiments, R⁴ is a substituted C₈-C₁₀ alkyl. In some embodiments, R⁴ is an unsubstituted C₆-C₉ alkyl. In other embodiments, R⁴ is a C₈-C₁₀ alkyl group substituted with at least one hydroxyl group. In some embodiments, R⁴ is a C₁₀ alkyl group substituted with at least two hydroxyl groups. In other embodiments, R⁴ is a C₈ alkyl group substituted with at least one —SO₃H group. In some embodiments, R⁴ is a substituted C₉ group, wherein at least two of the carbons on the carbon backbone form a heterocyclic group. In some embodiments, the heterocyclic group is an epoxide group. In some, embodiments, R⁴ is a C₈-C₉ substituted or unsubstituted alkyl, and R⁴ is a C₇-C₈ substituted or unsubstituted alkyl.

According to an embodiment, in the hydraulic fracturing fluid made by adding the additive to the treated water formed by subjecting the oilfield waste water to the hydrogen peroxide, the breaker is encapsulated in an encapsulating material to prevent the breaker from being dispersed and contacting other components of the treated water until a predetermined time such as after proppant placement or after fracturing has occurred. The encapsulating material is configured to release the breaker in response to a breaking condition (e.g., time, pressure, temperature, solvent contact, contact with an activator, and the like). The breaker is a solid or liquid. As a solid, the breaker is, e.g., a crystalline or granular material. In an embodiment, the solid is encapsulated or provided with a coating to delay its release or contact with other fracturing fluid components. Encapsulating materials are polymers or compounds that adhere well to molecules of the breaker. Methods of disposing the encapsulating material on the breaker are discussed in relation to the proppant. In an embodiment, a liquid breaker is dissolved in an aqueous solution or another suitable solvent.

In an embodiment, the encapsulation material is a polymer that releases the breaker in a controllable way, e.g., at a controlled rate or concentration. Such material is a polymer that degrades over a period of time to release the breaker and is chosen depending on the release rate desired. Degradation of the polymer of the encapsulation material polymer occurs, e.g., by hydrolysis, solvolysis, melting, and the like. In an embodiment, the polymer of the encapsulation material is a homopolymer or copolymer of glycolate and lactate, a polycarbonate, a polyanhydride, a polyorthoester, a polyphosphacene, or a combination thereof.

According to an embodiment, the encapsulated breaker is an encapsulated hydrogen peroxide, encapsulated metal peroxides (e.g., sodium peroxide, calcium peroxide, zinc peroxide, and the like) or any of the peracids or other breaker herein.

In an embodiment, the treated water also includes a fluid. The fluid is an aqueous liquid that includes water, brine, mineral acid, organic acid, or a combination comprising at least one of the foregoing. The brine is, for example, seawater, produced water, completion brine, or a combination thereof. The properties of the brine can depend on the identity and components of the brine. Seawater, as an example, contains numerous constituents such as bromine and trace metals, beyond typical halide-containing salts. In addition to the naturally occurring brines, completion brine is synthesized from fresh water by addition of various salts such as KCl, NaCl, ZnC₂, MgCl₂, or CaCl₂ to increase the density of the brine, such as 10.6 pounds per gallon of CaCl₂ brine. Completion brines typically provide a hydrostatic pressure optimized to counter the reservoir pressures downhole. In an embodiment, the above brines are modified to include an additional salt. In an embodiment, the additional salt included in the brine is NaCl, KCl, NaBr, MgCl₂, CaCl₂, CaBr₂, ZnBr₂, NH₄Cl, sodium formate, cesium formate, and the like. The salt is present in the brine in an amount from about 0.5 weight percent (wt %) to about 50 wt %, specifically about 1 wt % to about 40 wt %, and more specifically about 1 wt % to about 25 wt %, based on the weight of the fluid.

According to an embodiment, the fluid is a mineral acid that includes hydrochloric acid, nitric acid, phosphoric acid, sulfuric acid, boric acid, hydrofluoric acid, hydrobromic acid, perchloric acid, or a combination comprising at least one of the foregoing. In some embodiments, the fluid is an organic acid that includes a carboxylic acid, sulfonic acid, or a combination thereof. Exemplary carboxylic acids include formic acid, acetic acid, chloroacetic acid, dichloroacetic acid, trichloroacetic acid, trifluoroacetic acid, proprionic acid, butyric acid, oxalic acid, benzoic acid, phthalic acid (including ortho-, meta- and para-isomers), and the like. Exemplary sulfonic acids include alkyl sulfonic acid or aryl sulfonic acid. Alkyl sulfonic acids include, e.g., methane sulfonic acid. Aryl sulfonic acids include, e.g., benzene sulfonic acid or toluene sulfonic acid. In one embodiment, the alkyl group may be branched or unbranched and contains from one to about 20 carbon atoms and is substituted or unsubstituted. In an embodiment, the aryl group is alkyl-substituted, i.e., is an alkylaryl group, or is attached to the sulfonic acid moiety via an alkylene group (i.e., an arylalkyl group). In an embodiment, the aryl group is substituted with a heteroatom. The aryl group has from 3 carbon atoms to 20 carbon atoms and includes, e.g., a polycyclic ring structure.

Additionally, the additive is a proppant. The proppant is particles (also referred to as proppant particles) that include a ceramic, sand, a mineral, a nut shell, gravel, glass, resinous particles, polymeric particles, or a combination thereof. In an embodiment, the proppant particles are selected depending on the particular application of the treated water. Examples of the ceramic include an oxide-based ceramic, nitride-based ceramic, carbide-based ceramic, boride-based ceramic, silicide-based ceramic, or a combination thereof. In an embodiment, the oxide-based ceramic is silica (SiO₂), titania (TiO₂), aluminum oxide, boron oxide, potassium oxide, zirconium oxide, magnesium oxide, calcium oxide, lithium oxide, phosphorous oxide, titanium oxide, or a combination thereof. The oxide-based ceramic, nitride-based ceramic, carbide-based ceramic, boride-based ceramic, or silicide-based ceramic contain a nonmetal (e.g., oxygen, nitrogen, boron, carbon, or silicon, and the like), metal (e.g., aluminum, lead, bismuth, and the like), transition metal (e.g., niobium, tungsten, titanium, zirconium, hafnium, yttrium, and the like), alkali metal (e.g., lithium, potassium, and the like), alkaline earth metal (e.g., calcium, magnesium, strontium, and the like), rare earth (e.g., lanthanum, cerium, and the like), or halogen (e.g., fluorine, chlorine, and the like). Exemplary ceramics include zirconia, stabilized zirconia, mullite, zirconia toughened alumina, spinel, aluminosilicates (e.g., mullite, cordierite), perovskite, silicon carbide, silicon nitride, titanium carbide, titanium nitride, aluminum carbide, aluminum nitride, zirconium carbide, zirconium nitride, iron carbide, aluminum oxynitride, silicon aluminum oxynitride, aluminum titanate, tungsten carbide, tungsten nitride, steatite, and the like, or a combination thereof.

Examples of suitable sands for the proppant particles include, but are not limited to, Arizona sand, Wisconsin sand, Badger sand, Brady sand, and Ottawa sand. In an embodiment, the proppant particles are made of a mineral such as bauxite and are sintered to obtain a hard material. In an embodiment, the bauxite or sintered bauxite has a relatively high permeability such as the bauxite material disclosed in U.S. Pat. No. 4,713,203, the content of which is incorporated by reference herein in its entirety.

Naturally occurring proppant particles include nut shells such as walnut, coconut, pecan, almond, ivory nut, brazil nut, and the like; seed shells of fruits such as plum, olive, peach, cherry, apricot, and the like; seed shells of other plants such as maize (e.g., corn cobs or corn kernels); wood materials such as those derived from oak, hickory, walnut, poplar, mahogany, and the like. Such materials are particles formed by crushing, grinding, cutting, chipping, and the like.

In an embodiment, the proppant particles are coated, e.g., with a resin. That is, individual proppant particles have a coating applied thereto. In this manner, if the proppant particles are compressed during or subsequent to, e.g., fracturing, at a pressure great enough to produce fine particles therefrom, the fine particles remain consolidated within the coating so they are not released into the formation. It is contemplated that fine particles decrease conduction of hydrocarbons (or other fluid) through fractures or pores in the fractures and are avoided by coating the proppant particles. Coating for the proppant particles include cured, partially cured, or uncured coatings of, e.g., a thermoset or thermoplastic resin. Curing the coating on the proppant particles occurs before or after disposal of the proppant particles in the treated water or before or after disposal of the treated water downhole, for example.

In an embodiment, the coating is an organic compound that includes epoxy, phenolic, polyurethane, polycarbodiimide, polyamide, polyamide imide, furan resins, or a combination thereof. The phenolic resin is, e.g., a phenol formaldehyde resin obtained by the reaction of phenol, bisphenol, or derivatives thereof with formaldehyde. Exemplary thermoplastics include polyethylene, acrylonitrile-butadiene styrene, polystyrene, polyvinyl chloride, fluoroplastics, polysulfide, polypropylene, styrene acrylonitrile, nylon, and phenylene oxide. Exemplary thermosets include epoxy, phenolic (a true thermosetting resin such as resole or a thermoplastic resin that is rendered thermosetting by a hardening agent), polyester resin, polyurethanes, epoxy-modified phenolic resin, and derivatives thereof.

In an embodiment, the curing agent for the coating is nitrogen-containing compounds such as amines and their derivatives; oxygen-containing compounds such as carboxylic acid terminated polyesters, anhydrides, phenol-formaldehyde resins, amino-formaldehyde resins, phenol, bisphenol A and cresol novolacs, phenolic-terminated epoxy resins; sulfur-containing compounds such as polysulfides, polymercaptans; and catalytic curing agents such as tertiary amines, Lewis acids, Lewis bases; or a combination thereof.

In an embodiment, the proppant particles include a crosslinked coating. The crosslinked coating typically provides crush strength, or resistance, for the proppant particles and prevents agglomeration of the proppant particles even under high pressure and temperature conditions. In some embodiments, the proppant particles have a curable coating, which cure subsurface, e.g. downhole or in a fracture. The curable coating cures under the high pressure and temperature conditions in the subsurface reservoir. Thus, the proppant particles having the curable coating are used for high pressure and temperature conditions.

According to an embodiment, the coating is disposed on the proppant particles by mixing in a vessel, e.g., a reactor. Individual components, e.g., the proppant particles and resin materials (e.g., reactive monomers used to form, e.g., an epoxy or polyamide coating) are combined in the vessel to form a reaction mixture and are agitated to mix the components. Further, the reaction mixture is heated at a temperature or at a pressure commensurate with forming the coating. In another embodiment, the coating is disposed on the particle via spraying such as by contacting the proppant particles with a spray of the coating material. The coated proppant particles are heated to induce crosslinking of the coating.

The aforementioned additive is added, e.g., to the treated water formed from the oilfield waste water. Here, a composition that can be used to form the treated water includes the oilfield waste water, the hydrogen peroxide, the secondary oxidizer, the coagulant, the flocculant, the additive, or a combination comprising at least one of the foregoing. An amount of each component is adjustable to achieve a selected amount of sulfide oxidation, e.g., 100% conversion to sulfur, during a selected time period or under select conditions.

Before oxidizing the sulfide to sulfur, the oilfield waste water has a high or low sulfide content. In an embodiment, the sulfide is present in the oilfield waste water in an amount greater than 5,000 parts per million (ppm), specifically greater than 1,000 ppm, more specifically greater than 500 ppm, yet more specifically greater than 100 ppm, and even more specifically greater than 50 ppm, based on a weight of the oilfield waste water. In some embodiments, the sulfide is present in the oilfield waste water in an amount from 1 ppm to 50 ppm, based on a weight of the oilfield waste water. The method herein is applicable to water that has a sulfide content that is less than 1 ppm, based on the weight of the oilfield waste water.

After oxidizing the sulfide to sulfur, the sulfide is present in an amount less than 1 ppm, specifically less than 500 parts per billion (ppb), more specifically less than 5 ppb, even more specifically less than 50 parts per trillion (ppt), and yet more specifically less than 1 ppt, based on a weight of the oilfield waste water. In an embodiment, the sulfide is quantitatively oxidized to, e.g., sulfur so that none of the sulfide remains in the oilfield waste water after oxidation by the hydrogen peroxide.

To effect the oxidation of the sulfide in the oilfield waste water, the hydrogen peroxide is present in an amount from 1 ppm to 20,000 ppm, specifically 1 ppm to 1,000 ppm, based on a volume of the hydrogen peroxide added to the oilfield waste water. In an embodiment, the hydrogen peroxide is present in a carrier, e.g., a solvent such as water, alcohol, glycol, and the like that is added to the oilfield waste water such that the amount of hydrogen peroxide is present in the aforementioned amount in the carrier, based on the total volume of carrier and hydrogen peroxide. In an embodiment, the hydrogen peroxide is added to the oilfield waste water in an amount from 0.1 equivalent (eq.) to 100 eq., specifically 1 eq. to 20 eq., more specifically 1 eq. to 10 eq., and yet more specifically 1 eq. to 2.5 eq., based on a molar equivalence of the hydrogen peroxide added to the oilfield waste water and the sulfide present in the oilfield waste water prior to oxidizing the sulfide to sulfur.

The flocculant or coagulant is present in an amount from 5 ppm to 20,000 ppm, specifically 5 ppm to 10,000 ppm, more specifically 5 ppm to 1,000 ppm, and even more specifically 5 ppm to 200 ppm, based on the volume of the fluid. The iron catalyst is present in a trace amount to 5,000 ppm, more specifically 0.5 ppm to 50 ppm, based on the volume of the oilfield waste water. The additive is added to the treated water in an amount from 0 wt % to 30 wt %, specifically 0 wt % to 10 wt %.

According to an embodiment, the oxidation of the sulfide to sulfur occurs in the absence of a sulfide oxidation catalyst, e.g., a transition metal catalyst. Thus, addition of a catalyst such as nickel or vanadium is avoided. In one embodiment, a catalyst such as an iron catalyst, e.g., ferric sulfate, can be added. It should be appreciated that addition of a catalyst changes the oxidation reaction rate or the reaction pathways available during oxidation. It is contemplated that a branching ratio between partial oxidation of sulfide to sulfur and full oxidation of sulfide to sulfate is controlled via selection of a catalyst and a ratio of catalyst to hydrogen peroxide used in the sulfide oxidation process herein. As a result, the forming a sulfur precipitate is controllable.

In an embodiment, oxidation of the sulfide further includes adjusting a pH of the oilfield waste water. According to an embodiment, the pH is adjusted to be greater than 7. Here, the oxidation still forms the sulfur precipitate even in the absence of a sulfide oxidation catalyst. The pH of the oilfield waste water is adjusted by, e.g., addition of an acid, base, or buffer.

The efficacy of the hydrogen peroxide depends on a number of parameters, including the amount of the hydrogen peroxide added to the oilfield waste water, the amount of material that the hydrogen peroxide oxides (including sulfide and other oxidizable material), as well as other factors, including temperature, pressure and the like.

As an alternative to using ppm as a measure of the amount of the hydrogen peroxide in the oilfield waste water, a proxy for the amount of the hydrogen peroxide is used. In an embodiment, an oxidation reduction potential (ORP) of the oilfield waste water is determined. Without wishing to be bound by theory, it is recognized that ORP is a reliable indicator of the level of oxidation of the oilfield waste water. For reduced water, e.g., containing reduced metals (e.g., iron cations) or inorganic reducing agents (e.g., sulfide, bisulfide, and the like), the ORP is less than that for an oxidized water. In an embodiment, the ORP of the oilfield water is determined. Determining the ORP of the oilfield water is accomplished using, e.g., an ORP meter that has been standardized relative to a known electrode potential. By convention, a standard hydrogen electrode (SHE) has a potential of 0 millivolt (mV), and a potential of an Ag/AgCl reference electrode is +230 mV relative to the SHE at 25° C. Here, ORP potentials are referenced to the Ag/AgCl potential; thus, ORP potentials have an offset of 230 mV relative to the SHE at 25° C.

Reduced oilfield waste water has an ORP of less than 0 mV, and oxidizable material is effectively oxidized by hydrogen peroxide at an ORP value of greater than 0 mV. In an embodiment, the amount of the hydrogen peroxide present in the oilfield waste water is adjusted to an amount effective to decrease a total amount of oxidizable material, i.e., oxidize such material. In some embodiments, the amount of the hydrogen peroxide is adjusted such that the ORP of the oilfield waste water is greater than or equal to 0 mV, specifically greater than or equal to 50 mV, more specifically greater than or equal to 100 mV, and even more specifically greater than or equal to 150 mV, referenced to a Ag/AgCl reference electrode. In an embodiment, an organic material, an inorganic material, or a combination comprising at least one of the foregoing materials is oxidized by the hydrogen peroxide in addition to the sulfide in the oilfield waste water. The organic material is, e.g., a hydrocarbon, and the inorganic material is, e.g., a sulfide or a metal, including a metal cation such as ferrous or ferric cations. In an embodiment, the organic material or inorganic material present in the oilfield waste water is oxidized prior to combining the hydrogen peroxide and the oilfield waste water. It is contemplated that the hydrogen peroxide also has a biocidal effect after it performs its oxidation function in the oilfield waste water. In an embodiment, the hydrogen peroxide is added in an amount that exceeds the amount of hydrogen peroxide that is used in redox reactions with the sulfide, inorganic material, or organic material. Here, the amount of hydrogen peroxide is included in the oilfield waste water also to achieve a biocidal amount to reduce a number density of bacteria in the oilfield waste water.

In an embodiment, oxidizing the organic or inorganic material includes adding the secondary oxidizer to the oilfield waste water prior to or after combining the hydrogen peroxide and the oilfield waste water. The secondary oxidizer is the same or different as the biocide. According to an embodiment, the secondary oxidizer includes chlorine dioxide, hypochlorite, chlorine, or a combination comprising at least one of the foregoing. The secondary oxidizer is added to the oilfield waste water in an amount effective to oxidize the organic and inorganic material so that these materials do not suppress the oxidizing activity of the hydrogen peroxide with the sulfide. In an embodiment, the secondary oxidizer is added to the oilfield waste water in an amount such that the ORP of the oilfield waste water is greater than or equal to 0 mV, specifically greater than or equal to 10 mV, and more specifically greater than or equal to 50 mV, referenced to an Ag/AgCl reference electrode. In some embodiments, the ORP value is from 100 mV to 800 mV upon adding the hydrogen peroxide.

According to an embodiment, the oilfield waste water is treated by measuring an oxidation reduction potential (ORP) of oilfield waste water and combining the oilfield waste water and the hydrogen peroxide. Thus, contacting the oilfield waste water with hydrogen peroxide includes adding the hydrogen peroxide to the oilfield waste water in an amount effective to increase an oxidation reduction potential (ORP) of the oilfield waste water to a value greater than 0 mV, referenced to a Ag/AgCl reference electrode. Particularly, after adding the hydrogen peroxide, the ORP is greater than or equal to 50 mV, referenced to the Ag/AgCl reference electrode.

In an embodiment, determination of the ORP value of the oilfield waste water occurs before, after, or during contacting oilfield waste water with hydrogen peroxide in the absence of a sulfide oxidizing catalyst, oxidizing sulfide to sulfur, and forming a colloidal sulfur precipitate, a bulk sulfur precipitate, or a combination comprising at least one of the foregoing.

The oxidation of the sulfide by the hydrogen peroxide is facile, occurring in a time less than or equal to 5 minutes. The oxidation time can be lengthened to 30 minutes, 24 hours, or longer depending on controlling such factors as an amount of hydrogen peroxide added to the oilfield waste water. Moreover, the oxidation is applicable to downhole or aboveground.

Upon oxidation of the sulfide, a precipitate is formed that includes sulfur or other insoluble compound in some embodiments. In an embodiment, no precipitate is formed until addition of the flocculant or coagulant. The precipitate is removed from the oilfield waste water or treated water by, e.g., addition of a coagulant or flocculant. In an embodiment, the coagulant or flocculant is added to the oilfield waste water coincidentally with the hydrogen peroxide such that, when the hydrogen peroxide is introduced into the oilfield waste water, the coagulant or flocculant is also present. In some embodiments, the coagulant or flocculant is introduced into the oilfield waste water before or after the hydrogen peroxide is added to the oilfield waste water. Thus, the hydrogen peroxide, coagulant, and flocculant are introduced in the oilfield waste water coincidentally or asynchronously. Thus, in a particular embodiment, the coagulant or flocculant is added to the oilfield waste water after formation of the sulfur, i.e., after oxidation of the sulfide. Without wishing to be bound by theory, it is believed that the flocculant or coagulant accumulates a plurality of precipitate particles to form a large mass of insoluble material with respect to the water. In an embodiment, the flocculant bridges precipitate particles, resulting in more efficient settling. According to an embodiment, an aggregate precipitate is formed by adding the coagulant, flocculant, or combination thereof to the oilfield waste water. Therefore, the oilfield waste water is subjected to clarifying by contacting the oilfield waste water with a coagulant, a flocculant, or a combination comprising at least one of the foregoing.

To increase the amount of oxidation of the sulfide by partial oxidation to sulfur or aggregate precipitate formed and to decrease the time for oxidation or aggregate precipitate formation, the hydrogen peroxide, flocculant, or coagulant are mixed with the oilfield waste water so that these components are distributed uniformly together. Such mixing increases the relative kinetic motion and collision rate of the components (e.g., the precipitate formed and the flocculant). Mixing includes static or dynamic mixing using elements such as contoured surfaces in the mixing environment, nozzles to inject the components, fans, blades, impellers, blenders, bubblers, injectors, and the like.

In an embodiment, motion in the environment is decreased or eliminated so that the aggregate precipitate forms efficiently. Moreover, the environment is made to be nearly or very still in order to increase the size or amount of the aggregate precipitate of the precipitate particles.

The environment in which the hydrogen peroxide, oilfield waste water, flocculant, coagulant, treated water, or additive is combined is any number of structures for combining such materials. Exemplary environments include a container, vessel, pond, tank, pipe, tube, tubular, formation, Weir tank, separator, and the like. In an embodiment, the environment is open so that a surface of the oilfield waste water is exposed, enclosed, isolated, and the like. Applying pressure to the environment or decreasing a pressure of headspace above the oilfield waste water (or treated water) is accomplished in an enclosed container. Such a container includes vents and piping or a tube for delivery or removal of components (e.g. hydrogen peroxide, oilfield waste water, flocculant, coagulant, treated water, or additive) thereto.

Upon formation of the aggregate precipitate, it can be separated from the oilfield waste water by filtering the aggregate precipitate therefrom, centrifuging the aggregate precipitate and the oilfield waste water and collecting the oilfield waste water as treated water, skimming the aggregate precipitate from the oilfield waste water (or treated water), or a combination thereof. Any number of ways to separate the aggregate precipitate from the oilfield waste water (or treated water) is used.

In an embodiment, after removal of the aggregate precipitate by separation from the oilfield waste water, the oilfield waste water is processed into treated water for use as a hydraulic fracturing fluid, for usage in enhanced or improved oil recovery, for storage, or for disposal. Thus, the oilfield waste water is reclaimed after removal of the aggregate precipitate. In processing the oilfield waste water for use as a hydraulic fracturing fluid, additives are added to the treated water. Thereafter, the resulting hydraulic fracturing fluid is injected downhole for fracturing. In some embodiments, an aggregate precipitate is not formed, and the treated water is made from the oilfield waste water after oxidation of the sulfide.

Thus, in an embodiment, a process for recycling oilfield waste water includes optionally adjusting a pH of oilfield waste water such that the pH is greater than 7; combining the oilfield waste water and hydrogen peroxide; oxidizing the sulfide to sulfur; forming a precipitate comprising a colloidal sulfur precipitate, a bulk sulfur precipitate, or a combination comprising at least one of the foregoing; removing the precipitate from the oilfield waste water to form treated water; introducing an additive to the treated water; and disposing the treated water in a subterranean environment. Thereafter, the treated water is pressurized to fracture the subterranean environment. According to an embodiment, a secondary oxidizer is added to contact the oilfield waste water prior to combining the oilfield waste water with the hydrogen peroxide.

Prior to injecting the treated water in the subterranean environment (e.g., downhole), the oilfield waste water is combined with the hydrogen peroxide in a first container and the resulting composition is transferred to a settling tank for removal of an aggregate precipitate. In some embodiments, the method is a dynamic flow method wherein contacting the oilfield waste water with the hydrogen peroxide comprises combining the oilfield waste water and the hydrogen peroxide in a flowing stream. According to an embodiment, contacting the oilfield waste water with the hydrogen peroxide comprises disposing the oilfield waste water and hydrogen peroxide together in a storage container. In a particular embodiment, the treated water is disposed in a tank from which the treated water is delivered to a well or a transport vessel.

The treated water is any number of fluids useful in hydrocarbon and gas production and completion. In an embodiment, the treated water is a hydraulic fracturing fluid that includes slickwater or a crosslink fluid, an enhanced oil recovery fluid, a completion fluid, a drilling fluid, or a combination comprising at least one of the foregoing.

In the treated water, the sulfide is present in an amount less than 0.5 ppm or greater, e.g., 50 ppm. After oxidizing the sulfide to sulfur, the sulfide is present in an amount less than 1 ppm, specifically less than 500 ppb, more specifically less than 5 ppb, even more specifically less than 50 ppt, and yet more specifically less than 1 ppt, based on a weight of the treated water. In an embodiment, the sulfide is quantitatively oxidized to, e.g., sulfur so that none of the sulfide is present in the treated water.

The hydrogen peroxide rapidly oxidizes the sulfide in the oilfield waste water. In an embodiment, oxidizing the sulfide to sulfate is complete in less than two days, specifically less than one day, more specifically less than 12 hours, even more specifically less than two hours, and yet even more specifically less than five minutes after contacting the hydrogen peroxide. The method herein can occur over a wide pH range. According to an embodiment, the method, and in particular, oxidizing sulfide to sulfur, occurs at every pH from 0 to 12, more specifically at an acidic pH (pH<7), a neutral pH (pH=7), or alkaline pH (pH >7). In an embodiment, a buffer is added to the oilfield waste water or the oilfield waste water is buffered so that the pH of the oilfield waste water does not change or does not change much (e.g., <5%) during the oxidation of the sulfide by the hydrogen peroxide.

The treated water has beneficial properties. In an embodiment, the viscosity of the treated water is great enough to suspend and transport the proppant and other additives at a temperature above the freezing point of water, specifically greater than 100 centipoise (cp), more specifically greater than 300 cp, more specifically greater than 400 cp, as measured, and even more specifically from 150 cp to 1,000 cp, as measured, for example, by a dual cup rotating viscometer at 26° C.

With respect to the hydraulic fracturing fluid, the proppant particles are present in an amount effective to prop open a fracture without the geometry of the fracture being altered during settling of the formation. In a particular embodiment, the proppant particles are present in a mass concentration from 0.1 pounds per gallon (lb/gal) to 20 lb/gal, specifically 0.25 lb/gal to 16 lb/gal, and more specifically 0.25 lb/gal to 12 lb/gal, based on the total volume of the treated water. In an embodiment, the breaker is present in the treated water in a mass concentration from 0 ppt to 20 ppt, specifically 0 ppt to 15 ppt, and more specifically, 0 ppt to 10 ppt, based on the total volume of the treated water. In some embodiments, the biocide is present in an amount from 10 ppm to 2,000 ppm, specifically 50 ppm to 1,500 ppm, and more specifically 50 ppm to 1,000 ppm.

In an embodiment, combining the components of the treated water is accomplished in a vessel such as a mixer, blender, and the like. In some embodiments, the treated water is injected without mixing, e.g. it is injected “on the fly”. The components are mixed, agitated, stirred, and the like. In an embodiment, the components are combined as the treated water is being disposed downhole. The treated water herein has advantageous properties that include suspending the proppant particles for an extended period of time or at an elevated temperature or pressure.

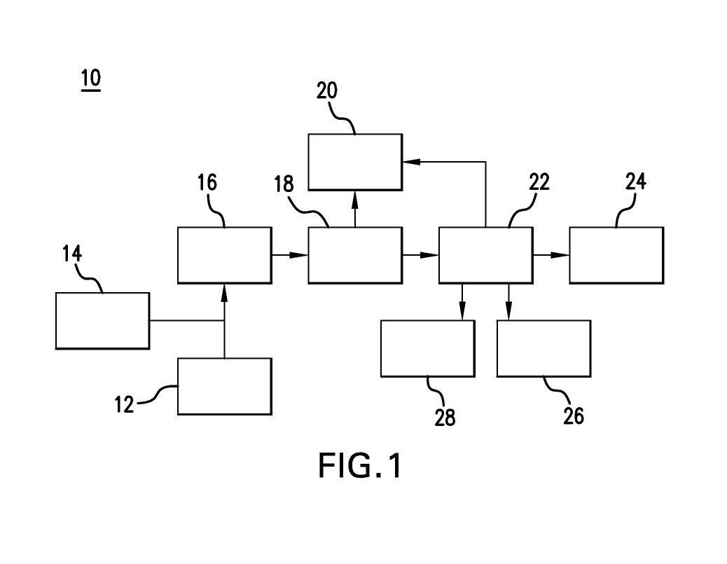

As show in FIG. 1, an oilfield waste water system 10 includes an oilfield waste water source 12 that is combined with hydrogen peroxide from a hydrogen peroxide source 14. The two fluids are combined in a static or dynamic mixer 16 and transferred to a separator 18. The separator 18 separates a gas phase and a liquid phase with the gas being disposed in gas storage/transfer container 20, and the liquid phase communicated to container 22 (which is a treater, battery, or liquid-solid separator). Thereafter, an aqueous phase (i.e., the treated water) is communicated to treated water storage/transfer member 28, and solids are communicated to container 26. Also, an organic liquid phase (e.g., a hydrocarbon liquid) is communicated from the container 22 to liquid hydrocarbon storage/transfer member 24. It is contemplated that the arrangement, configuration, separation, and storage components of the oilfield waste water system 10 is variable and be reconfigured as desired.

According to an embodiment, a fluid, e.g., natural gas with or without waste water, is subjected to oxidation by hydrogen peroxide as previously described to decrease the amount of H₂S in the natural gas. The treated natural gas is recovered with a lower or no H₂S content and is stored, recycled, distributed, or sold.

The processes herein for oxidation of sulfide in oilfield waste water and formation of treated water are further illustrated by the following non-limiting example.

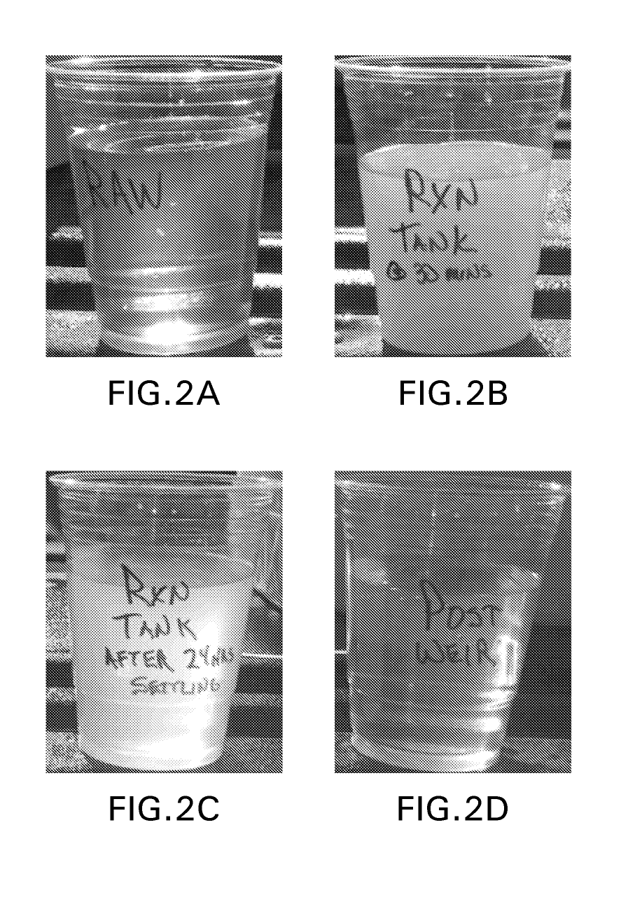

Example. Produced water was acquired from a well. The raw produced water contained greater than ppm H₂S and had an ORP of less than 200 mV. At room temperature, hydrogen peroxide was added to the produced water to achieve from 1000 ppm to 2000 ppm hydrogen peroxide in the produced water. After 30 minutes, the ORP of the water was greater than 50 mV with an H₂S amount of 0 ppm. The water was allowed to settle for 24 hours at which time it had an ORP of less than 10 mV. Thereafter the water was subjected to clarification in a Weir tank to make treated water having an ORP of less than 5 mV. FIG. 2 shows photographs of samples of the oilfield water during the phases of treatment, where panel A is the raw oilfield waste water; B is the water 30 minutes after adding the hydrogen peroxide; C is the water after 24 hours; and D is the water after clarification in the Weir tank.

While the raw oilfield waste water had a green-yellow color due to sulfide in the water, the water assumed a milky white precipitate immediately after introduction of hydrogen peroxide. The milky white appearance is obvious in panels B and C of FIG. 2. The precipitate was efficiently removed in the Weir tank as evidenced by the colorless, clear treated water shown in panel D of FIG. 2.

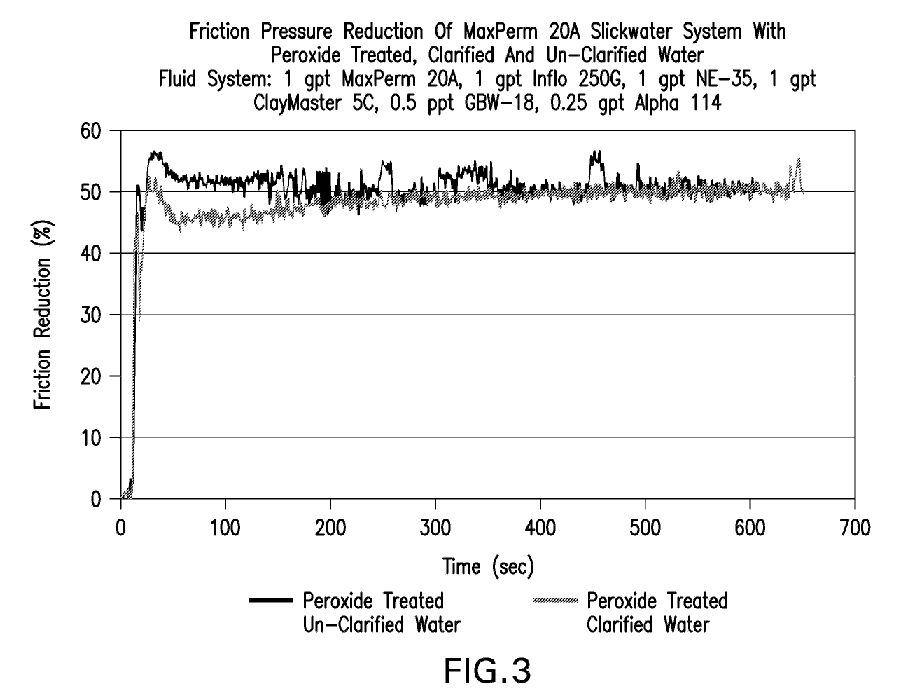

The treated water was subjected to further testing to determine its operation characteristics as a fracturing fluid. After the produced water was treated to remove the hydrogen sulfide, several additives were added to two samples of the treated water. The additives included friction reducer, nonemulsifiers, biocides, guar and buffers. One sample was not clarified, and the other sample was clarified. Both samples were subjected to friction pressure reduction tests, and the results plotted in the graph shown in FIG. 3. The small scale friction loop included a small positive displacement pump having a pumping capacity from 0.5 to 3.25 gpm, a pressures gauge, and 20 ft. of ¼″ tube coiled in a circle of 1.5 ft. diameter. The fluid is circulated from a tank into the pump via a large ½″ stainless steel tube through the 20 ft. section of coiled tubing and returned into the top of the same tank. The test fluid is re-circulated through the coil continuously throughout the test. Generally, the test volume is 3000 mL of fluid. Friction reducer or other appropriate additive is added to the tank while mixed via an overhead mixer and re-circulated. The fluid is first circulated at approximately 3 gpm for the first 90 seconds of the test. The friction reducer is usually added 10 seconds after starting the test, and the rate is held constant for 90 seconds unless the fluid has not completely hydrated, in which case the flow rate is held constant until the differential pressure stabilizes. Once the initial hydration data is captured for approximately 90 seconds, the flow rate is decreased in equal increments down to 0.5 gpm, and the test is terminated.

As illustrated by the graph of temporal friction reduction data shown in FIG. 3, both un-clarified and clarified treated water samples showed high friction reduction (>45%) after 150 seconds. Although the un-clarified water exhibited higher friction reduction than the clarified water at early times (<150 seconds), both treated water samples, obtained a similar asymptotic value of 50% friction reduction. This level of friction reduction is highly advantageous in a hydraulic fracturing fluid and more generally in a downhole fluid.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). The conjunction “or” is used to link objects of a list or alternatives and is not disjunctive; rather the elements can be used separately or can be combined together under appropriate circumstances.

What is claimed is:

1. A process for treating oilfield waste water, the process comprising:
contacting the oilfield waste water with hydrogen peroxide, the oilfield waste water comprising sulfide;
oxidizing the sulfide to sulfur; and
precipitating the sulfur to form treated water from the oilfield waste water.

2. The process of claim 1, further comprising removing the precipitated sulfur from the treated water.

3. The process of claim 2, wherein removing the precipitated sulfur comprises contacting the sulfur with a coagulant, flocculant, or a combination comprising at least one of the foregoing, to form an aggregate precipitate.

4. The method of claim 3, further comprising separating, from the oilfield waste water, the aggregate precipitate.

5. The process of claim 1, wherein contacting the oilfield waste water with hydrogen peroxide occurs in the absence of a sulfide oxidation catalyst.

6. The process of claim 1, wherein contacting the oilfield waste water with hydrogen peroxide comprises adding the hydrogen peroxide to the oilfield waste water in an amount effective to increase an oxidation reduction potential (ORP) of the oilfield waste water to a value greater than 0 mV, referenced to a Ag/AgCl reference electrode.

7. The process of claim 6, wherein, after adding the hydrogen peroxide, the ORP is greater than or equal to 50 mV, referenced to an Ag/AgCl reference electrode.

8. The process of claim 1, further comprising introducing a secondary oxidizer to the oilfield waste water.

9. The process of claim 8, wherein the secondary oxidizer preferentially oxidizes organic material relative to the sulfide in the oilfield waste water.

10. The process of claim 9, wherein the secondary oxidizer comprises chlorine dioxide, hypochlorite, chlorine, or a combination comprising at least one of the foregoing.

11. The process of claim 1, wherein the oilfield waste water comprises produced water, flowback water, pit water, or a combination comprising at least one of the foregoing.

12. The process of claim 1, wherein the hydrogen peroxide is added to the oilfield waste water in an amount from 1 equivalent to 10 equivalent, based on a molar equivalence of the hydrogen peroxide added to the oilfield waste water and the sulfide present in the oilfield waste water prior to oxidizing the sulfide to sulfur.

13. The process of claim 1, wherein the sulfide in the treated water is present in an amount which is less than 99% of the amount of the sulfide present in the oilfield waste water prior to oxidizing the sulfide to sulfur.

14. The process of claim 1, wherein oxidizing the sulfide to sulfur occurs in a time less than or equal to 5 minutes.

15. The process of claim 1, wherein contacting the hydrogen peroxide and the oilfield waste water occurs aboveground.

16. A process for treating oilfield waste water, the process comprising:
contacting oilfield waste water with hydrogen peroxide in the absence of a sulfide oxidizing catalyst, the oilfield waste water comprising sulfide;
oxidizing sulfide to sulfur; and
forming a colloidal sulfur precipitate, a bulk sulfur precipitate, or a combination comprising at least one of the foregoing.

17. A process for recycling oilfield waste water, the process comprising:
combining the oilfield waste water and hydrogen peroxide, the oilfield waste water comprising sulfide;
oxidizing the sulfide to sulfur;
forming a precipitate comprising a colloidal sulfur precipitate, a bulk sulfur precipitate, or a combination comprising at least one of the foregoing;
removing the precipitate from the oilfield waste water to form treated water;
introducing an additive to the treated water; and
disposing the treated water in a subterranean environment.

18. The process of claim 17, further comprising contacting the oilfield waste water with a secondary oxidizer prior to combining the oilfield waste water with the hydrogen peroxide.

19. The process of claim 17, further comprising pressurizing the treated water to fracture the subterranean environment.

20. The method of claim 17, wherein the treated water is a hydraulic fracturing fluid comprising slickwater or a crosslink fluid; an enhanced oil recovery fluid; a completion fluid; a drilling fluid; or a combination comprising at least one of the foregoing.
